(19) United States
(12) Patent Application Publication
(10) Pub. No.: US 2011/0221188 A1
(43) Pub. Date: Sep. 15, 2011

(54) PROTECTIVE DEVICE FOR INDUSTRIAL FITTING

(76) Inventors: John Fuller, Anaheim, CA (US); Michael Casey, Anaheim, CA (US)

(21) Appl. No.: 13/043,825

(22) Filed: Mar. 9, 2011

Related U.S. Application Data
(60) Provisional application No. 61/313,025, filed on Mar. 11, 2010.

(51) Int. Cl. F16L 37/18

(52) U.S. Cl. 285/312

(57) ABSTRACT

Embodiments of the invention are directed to devices and methods to partially, substantially or completely alleviate premature wear-and-tear and damage to fittings used in conjunction with industrial hoses during repeated use. In one embodiment, a device includes one or more rings adapted to position about a portion of the fitting. In one embodiment, the ring may include one or more notches corresponding to one or more features on the fitting. In another embodiment, the ring does not include any notches.

### CLAIM OF PRIORITY UNDER 35 U.S.C. §119

The present application for patent claims priority to U.S. Provisional Application No. 61/313,025 entitled “PROTECTIVE DEVICE FOR INDUSTRIAL FITTING”, filed Mar. 11, 2010 and is hereby expressly incorporated by reference herein.

### FIELD OF INVENTION

At least one feature pertains to a protective device for protecting a fitting attached to an industrial hose.

### BACKGROUND OF INVENTION

Industrial hoses are used for plant, in-site or bulk transfer applications of various chemicals and materials in numerous industries including, but not limited to, the petroleum/oil/gasoline industry, the chemical industry, the processed water industry, the sanitation industry and other specialty and general purpose industries. In the petroleum industry, for example, it is commonly known that the gasoline sold at service stations is stored underground in buried tanks. Each storage tank may hold several thousand gallons of gas.

Typically, the underground storage tanks are refilled from time to time by specialized mobile tank trucks which deliver gas directly into the underground storage tanks. Generally, gasoline is transferred from the tank truck directly to the underground storage tank via an industrial hose. The operator of the tank truck typically fits one end of the industrial hose to an outlet on the tank truck and fits the other end to an inlet (usually embedded in the ground) leading to the underground storage tank. The industrial hose is held in place by specialized fittings. The specialized fittings, known as quick connect/disconnect fittings or cam-lock fittings, are generally specially manufactured and can be costly to manufacture and replace. When the operator is performing the procedures as described, these fittings are often dragged along the ground or dropped on the ground resulting in damage and a shortened lifetime of the fitting.

Consequently, a device is needed that partially, substantially or completely alleviates premature wear-and-tear and damage to fittings used in conjunction with industrial hoses during repeated use.

### SUMMARY OF INVENTION

One feature is directed to protective device for protecting a fitting attached to an industrial hose. The protective device comprises at least one ring having an outer diameter and an inner diameter, the at least one ring having two notches on the outer diameter thereof, the two outer diameter notches positioned 180° relative to one another, each outer diameter notch sized to accommodate a cam-lock arm of an industrial fitting wherein, when positioned on the industrial fitting, the industrial fitting coupled to the industrial hose, the ring prevents the industrial fitting from making contact with a horizontal surface. An inner diameter notch is positioned 90° relative to either of the outer diameter notches and sized to accommodate a locking keyway of the industrial fitting.

The ring is generally flat or substantially flat, made from a rigid material having a shock-absorbing characteristic and permanently affixed to the industrial fitting. Furthermore, the outer diameter of the ring is larger than an outer diameter of the industrial fitting.

Yet another feature is directed to combination device for preventing premature wear-and-tear and damage to fittings used in conjunction with industrial hoses during repeated use. The combination device comprises: (a) an industrial hose; (b) an industrial fitting having a stem portion and a head portion coupled to the industrial hose; and (c) a ring positioned on the stem portion of the industrial fitting between the head portion of the industrial fitting and an opening in the industrial hose.

The ring has an inner diameter greater than an outer diameter of the stem portion of the industrial fitting but less than an outer diameter of the head portion of the industrial fitting and less than an outer diameter of the opening in the industrial hose. Furthermore, the ring has two notches on an outer diameter thereof and positioned 180° relative to one another where each notch sized to accommodate a cam-lock arm. An inner diameter notch is positioned 90° relative to either of the outer diameter notches on the ring and is sized to accommodate a locking keyway of the industrial fitting.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1A illustrates a device which may be used to partially, substantially or completely alleviate premature wear-and-tear and damage to a fitting used in conjunction with an industrial hose, according to one embodiment.

FIG. 1B illustrates a device which may be used to partially, substantially or completely alleviate premature wear-and-tear and damage to a fitting used in conjunction with an industrial hose, according to another embodiment.

FIG. 2 illustrates a device positioned on an industrial fitting, according to an embodiment of the invention.

FIG. 3 illustrates a pair of devices positioned on a male industrial fitting and a female fitting, respectively, according to an embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to devices and methods to partially, substantially or completely alleviate premature wear-and-tear and damage to fittings used in conjunction with industrial hoses during repeated use. In one embodiment, a device includes one or more rings adapted to position about a portion of the fitting. In one embodiment, the ring may include one or more notches corresponding to one or more features on the fitting. In another embodiment, the ring does not include any notches.

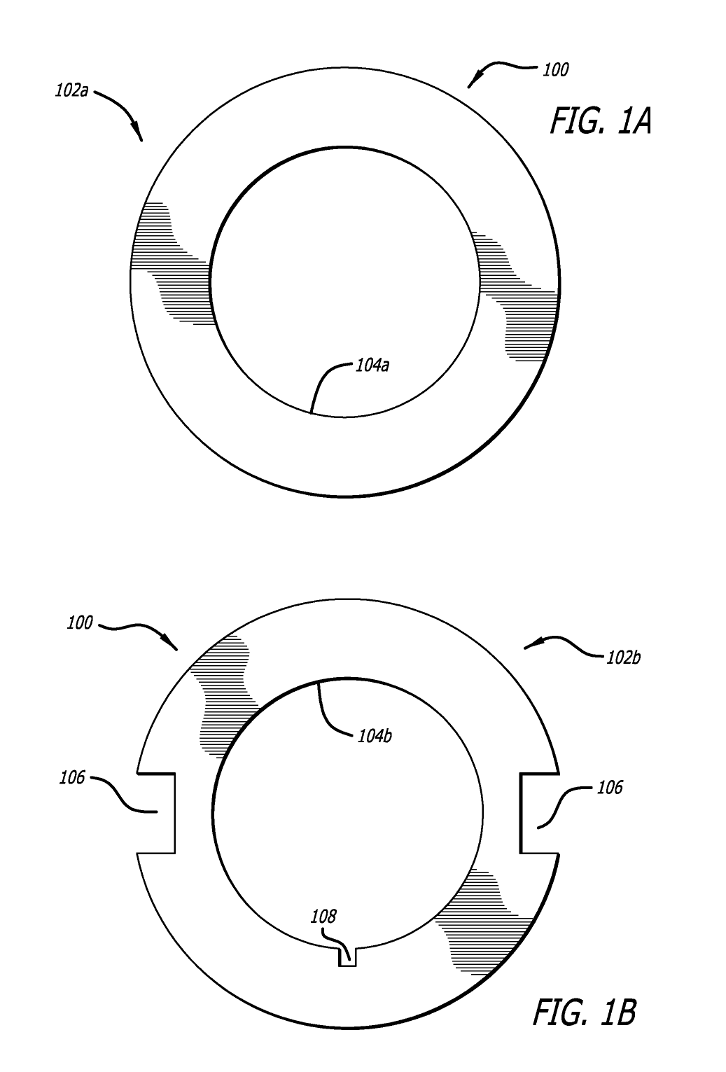

FIG. 1A illustrates a device which may be used to partially, substantially or completely alleviate premature wear-and-tear and damage to a fitting used in conjunction with an industrial hose, according to one embodiment. As shown, a device 100 comprises a flat or substantially flat ring 102a having an aperture 104a therein. Ring 102a may be made of material such as polypropylene, rubber, a combination thereof or an equivalent thereof. In any embodiment, the material should be substantially rigid yet have a shock-absorbing characteristic and should be able to withstand environmental conditions. Depending on the size of the fitting on which it is to be placed, the ring 102a may have an outer diameter (OD) of between seventy-six (76) millimeters and two hundred and three (203) millimeters and an inner diameter (ID) of between fifty (50) millimeters and one hundred and fifty-two (152) millimeters. Ring 102a may be adapted to fit on, for example, a male industrial fitting.

As shown in FIG. 1B, device 100 may also comprise, or alternatively comprise, a flat or substantially flat ring 102b having an aperture 104b therein and having one more notches on an inner and/or outer diameter thereof. Similar to ring 102a, ring 102b may be made of material such as polypropylene, rubber, a combination thereof or an equivalent thereof. Depending on the size of the fitting on which it is to be placed, the ring 102b may have an outer diameter (OD) of between seventy-six (76) millimeters and two hundred and three (203) millimeters and an inner diameter (ID) of between fifty (50) millimeters and one hundred and fifty-two (152) millimeters. Ring 102b may be adapted to fit on, for example, a female industrial fitting.

In the embodiment shown, ring 102b includes two notches 106 on the outer diameter and one notch 108 on the inner diameter. Outer diameter notches 106 may be spaced approximately 180° relative to one another and may be sized to accommodate a cam-lock arm of a fitting (e.g., a female fitting). Inner diameter notch 108 may be spaced approximately 90° relative to either of the outer diameter notches 106 and in between thereof. Inner diameter notch 108 may be sized to accommodate a locking keyway of the fitting. It should be appreciated that ring 102b may include any number of notches on both or either of an inner or outer diameter thereof. Such notches should be sized to accommodate different components or features of the particular fitting on which it is positioned.

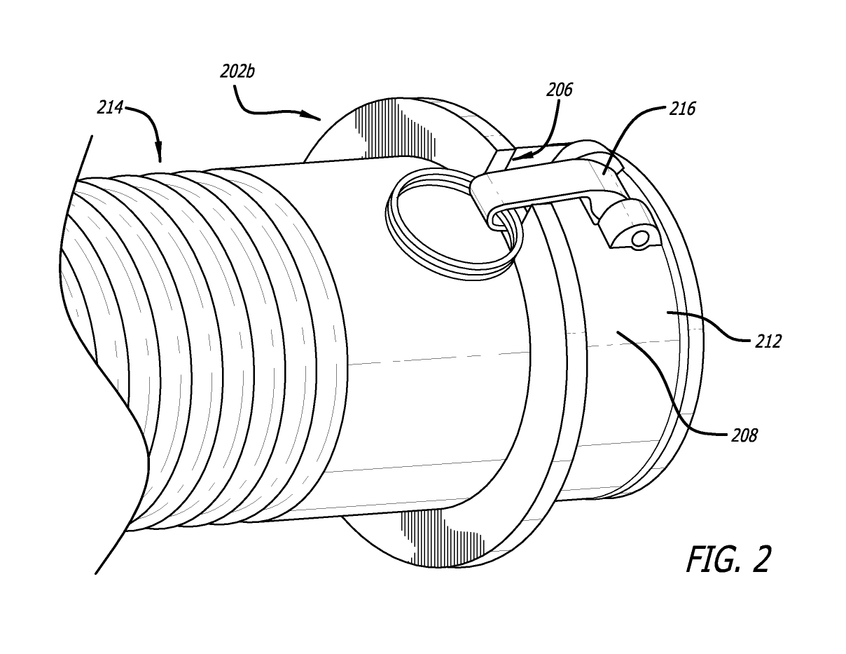

FIG. 2 illustrates a device positioned on an industrial fitting, according to an embodiment of the invention. As shown, the device in this embodiment is a ring 202b, with one or more outer diameter notches 206, positioned about an outer diameter of an industrial fitting 208. The industrial fitting 208 includes a stem portion and a head portion 212. The stem portion of the fitting 208 is coupled to an industrial hose 214. According to this embodiment, an outer diameter notch 206 on the ring 202b accommodates a cam-lock arm 216 of the industrial fitting 208 when positioned thereon. Although not shown, the ring 202b may include an inner diameter notch which may be partially, substantially or completely the same as the inner diameter notch 108 of FIG. 1B.

Ring 202b may be positioned about the stem portion of the fitting 208 on or around the area in which the fitting 208 is coupled to the hose 214. That is, the ring 202b may be positioned within a recess formed when the fitting 208 is coupled to the hose 214. As a result, the ring 202b is “locked” into place about the stem portion 210 of the fitting 208 when the cam-arm locks are coupled to the hose 214. In any embodiment, the OD of the ring 202b is greater than the OD of the fitting 208 and as a result, prevents the fitting 208 from making contact with the ground or other horizontal surface. In other words, the ring 202b protects the fitting 208 while the hose 214 is being dragged along the ground as well as when the hose 214 has been dropped.

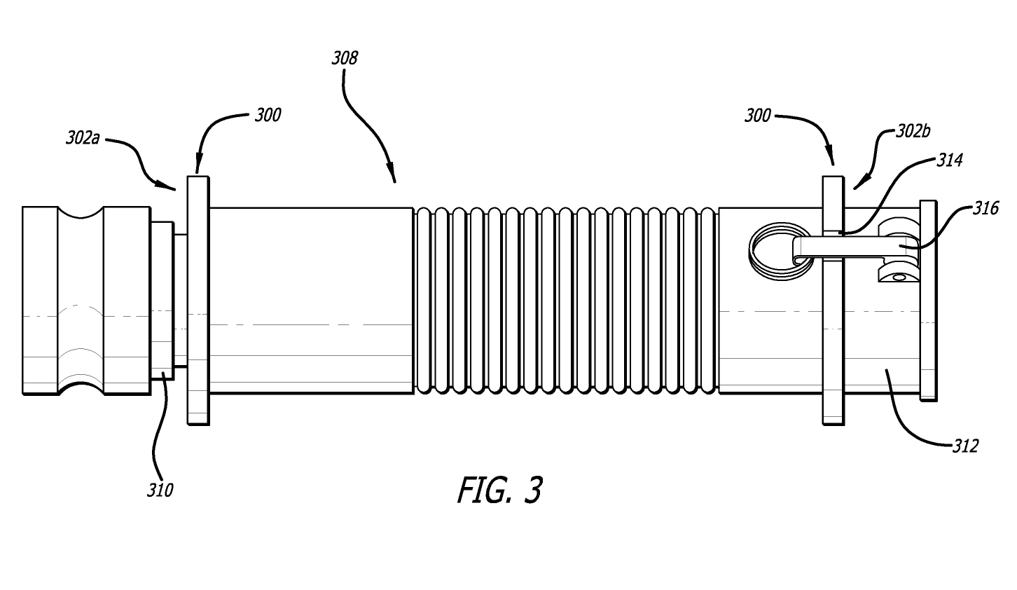

FIG. 3 illustrates a pair of devices 300 positioned on an industrial hose 308 having a male industrial fitting 310 and a female industrial fitting 312, respectively, according to an embodiment of the invention. As shown, the pair of devices 300 in this embodiment is a pair of rings 302a, 302b. Ring 302a is positioned on the male industrial fitting 310 while ring 302b is positioned on the female industrial fitting 312. The features and components of the pair of devices 300 may be partially, substantially or completely the same as those features/components described with reference to the devices in FIGS. 1A, 1B and 2. For example, ring 302a may be flat or substantially flat having an aperture therein and be partially, substantially or completely the same as ring 102a in FIG. 1A. Ring 302b may be flat or substantially flat having an aperture therein and be partially, substantially or completely the same as ring 102b in FIG. 1B and include one or more outer diameter notches 314 positioned about an outer diameter of the ring 302b as described above with reference to the devices in FIGS. 1B and 2. The one or more outer diameter notches 314 on the ring 302b can accommodate a cam-lock arm 316 of the female industrial fitting 312 when positioned thereon. In any embodiment, the OD of the rings 302a, 302b is greater than the OD of the fittings 310, 312 and as a result, prevents the fittings 310, 312 from making contact with the ground or other horizontal surface. Additionally, the rings 310, 312 may have an inner diameter greater than an OD of the stem portion of the fittings 310, 312 but less than an outer diameter of the head portion of the industrial fitting and less than an OD of the opening in the industrial hose.

According to methods of the invention, a device according to the embodiments described may be positioned on a stem side of an industrial fitting. The industrial fitting with the device positioned thereon may then be inserted into an opening or mouth of an industrial hose and crimped down onto the hose. By installing the device according to the embodiments described on industrial fittings, the life of the fitting can be dramatically increased. That is, the fittings are protected by the device when the fitting is dragged along the ground or dropped on the ground during the normal operation of manipulating the hose. The device may be permanently or removeably attached to any industrial fitting.

One or more of the components and functions illustrated in the figures may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A protective device for protecting a fitting attached to an industrial hose, comprising:
at least one ring having an outer diameter and an inner diameter, the at least one ring having two notches on the outer diameter thereof, the two outer diameter notches positioned 180° relative to one another, each outer diameter notch sized to accommodate a cam-lock arm of an industrial fitting wherein, when positioned on the industrial fitting, the industrial fitting coupled to the industrial hose, the ring prevents the industrial fitting from making contact with a horizontal surface.

2. The protective device of claim 1, further comprising an inner diameter notch positioned 90° relative to either of the outer diameter notches.

3. The protective device of claim 2, wherein the inner diameter notch is sized to accommodate a locking keyway of the industrial fitting.

4. The protective device of claim 1, wherein the outer diameter of the ring is larger than an outer diameter of the industrial fitting.

5. The protective device of claim 1, wherein the device is permanently affixed to the industrial fitting.

6. The protective device of claim 1, wherein the ring is flat.

7. The protective device of claim 1, wherein the device is made of a rigid material having a shock-absorbing characteristic.

8. The protective device of claim 1, wherein the device is made of a polypropylene or a rubber material.

9. A combination device for preventing premature wear-and-tear and damage to fittings used in conjunction with industrial hoses during repeated use, comprising:
an industrial hose;
an industrial fitting having a stem portion and a head portion coupled to the industrial hose; and
a ring positioned on the stem portion of the industrial fitting between the head portion of the industrial fitting and an opening in the industrial hose.

10. The combination device of claim 9, wherein the ring has an inner diameter greater than an outer diameter of the stem portion of the industrial fitting but less than an outer diameter of the head portion of the industrial fitting and less than an outer diameter of the opening in the industrial hose.

11. The combination device of claim 10, wherein the ring has two notches on an outer diameter thereof, the two outer diameter notches positioned 180° relative to one another, each notch sized to accommodate a cam-lock arm.

12. The combination device of claim 9, wherein the ring has an inner diameter notch positioned 90° relative to either of the outer diameter notches.

13. The combination device of claim 12, wherein the inner diameter notch is sized to accommodate a locking keyway of the industrial fitting.

14. The combination device of claim 9, wherein the ring is flat.

15. The combination device of claim 9, wherein the ring is made of a rigid material having a shock-absorbing characteristic.

16. The combination device of claim 9, wherein the ring is made of a polypropylene or a rubber material.

17. The combination device of claim 9, wherein the ring is permanently affixed to the industrial fitting.
